(19) United States
(12) Patent Application Publication
(10) Pub. No.: US 2014/0035864 A1
(43) Pub. Date: Feb. 6, 2014

(54) CAPACITIVE TOUCH-CONTROL PANEL AND APPARATUS THEREOF

(71) Applicant: ILI TECHNOLOGY CORP., Hsinchu County (TW)

(72) Inventors: MING-CHUNG CHANG, HSINCHU CITY (TW); JIM HSU, HSINCHU COUNTY (CA)

(73) Assignee: ILI TECHNOLOGY CORP., HSINCHU COUNTY (TW)

(21) Appl. No.: 13/750,255

(22) Filed: Jan. 25, 2013

(30) Foreign Application Priority Data
Aug. 1, 2012 (CN) 201210272566.0

(51) Int. Cl. G06F 3/044

(52) U.S. Cl. CPC G06F 3/044
USPC 345/174

(57) ABSTRACT

The present disclosure provides a capacitive touch panel which includes a substrate, M driving electrodes and M×N sensing electrodes, wherein M driving electrodes and M×N sensing electrodes are formed on the substrate. The M driving electrodes are placed parallel to a first axis and are electrically isolated from each other. Each of the M driving electrodes has N sensing electrode regions defined thereon along a second axis, wherein each sensing electrode region has a sensing electrode disposed therein. Each sensing electrode electrically isolated from the driving electrode. The sensing electrode and the corresponding driving electrode generate mutual capacitance. The area associated with each driving electrode is larger than the overall area of the each corresponding sensing electrode.

### BACKGROUND OF THE INVENTION

1. Field of the Invention

The present invention relates to a touch panel; in particular, to single-layer capacitive touch-control panel.

2. Description of Related Art

Recently, the electronic equipment, such as the cell phone [symbol] notebook computer and portable device, is with the touch-control displaying screen so as to be served as the input/output interface. The user may control the function of the electronic equipment correspondingly through controlling the electronic equipment via the touch-control displaying screen. The touch-control displaying screen has a touch-control panel and the touch-control panel may sense variation of the signal for each sensing unit, and thus the touch-control chip in the back-end may determine whether the sensing units are touched so as to judge the position. Additionally, the touch-control displaying screen may display information of the picture correspondingly according to the position of the touch point, or the processing circuit in the back-end may execute the predetermined function correspondingly according to the position of the touch point. Conventional touch-control panel includes the resistive, capacitive, optical, electromagnetic induction and sonic induction. Because the capacitive touch-control panel has an advantage of positioning precisely, the technology of the capacitive touch-control panel is widely used in market.

General capacitive touch-control panel is formed by the sensing units with a manner of array and the capacitive touch-control panel apparatus includes the capacitive touch-control panel and the touch-control chip, wherein the touch-control chip is electrically connected to the capacitive touch-control panel. The touch-control chip is electrically connected to each row or each column of the sensing units through a plurality of sensing signal lines, so as to sense the position of the touch point through the sensing signals transmitted from the sensing signal lines. When a finger touches one of the rows or one of the columns for any sensing units, the touched sensing unit may generate a potential variation due to the effect of field coupling, and the touch-control chip may acquire at least a touched location on the touch-control panel through detecting variation amounts of detecting signals transmitted by the detecting signal lines. Therefore, both the area associated with each of the sensing units and the variation of the electrical potential affect the accuracy for judging the touch point by the touch-control chip.

Because a size of capacitive touch-control panel is getting larger, the capacitive touch-control panel need bigger array of the sensing unit and more sensing signal lines correspondingly. Therefore, the density of the circuit layout for the capacitive touch-control panel is increased, so as to be interfered by noise easily. For example, the interference exists among the sensing units, and thus affects the accuracy for judging the touch point by the touch-control chip. Meanwhile, it enhances the complexity for circuit design on the capacitive touch-control panel.

### SUMMARY OF THE INVENTION

The present invention provides a capacitive touch-control panel. The capacitive touch-control panel includes a substrate, M driving electrodes and a plurality of M×N sensing electrodes. The M driving electrodes and the plurality of M×N sensing electrodes, located on the same layer, are formed on the substrate, and the driving electrodes are arranged along a first axis. Each of the driving electrodes set N sensing electrode regions, and then each of the plurality of sensing electrodes is disposed on the each of the sensing electrode regions so that the N sensing electrodes and the corresponding driving electrodes are insulated form each other, and the N sensing electrodes and the corresponding driving electrodes generate mutual capacitance. The area associated with each of the driving electrodes is larger than the overall area of the each corresponding sensing electrode, and M [symbol] N are positive integer.

In an embodiment of the present invention, each of the driving electrodes receives a driving signal correspondingly through a first conductive line, and each of the sensing electrodes correspondingly transmits a sensing signal through a second conductive line.

In an embodiment of the present invention, each of the sensing electrode regions on the substrate has a plurality of transparent regions, and the plurality of transparent regions set at least one first pad, wherein the first pads [symbol] the plurality of sensing electrodes and the driving electrodes are insulated electrically form each other.

In an embodiment of the present invention, each of the sensing electrodes has two first portions [symbol] a second portion and a plurality of protrusion portions, and the second portion is located between two adjacent first portions and is connected to the two first portions, wherein each of the first portions has a first side and a second side relative to the first side, and the second side is connected to the second portion, and the second side is larger than the first side. The plurality of protrusion portions are connected to the plurality of protrusion portions protrudes from the corresponding second portion, wherein the pad is disposed between the two protrusion portions and one of the protrusion portions transmits the sensing signal through the second conductive line.

In an embodiment of the present invention, each of the sensing electrode regions has L sensing sub-electrode regions, and the sensing sub-electrode regions are arranged along the second axis respectively in parallel, wherein a plurality of sensing sub-electrodes within the sensing sub-electrode regions are electrically connected to a second conductive line so as to form the sensing electrode, and the second conductive line transmits a sensing signal corresponding to the sensing electrode, wherein L is a positive integer.

In an embodiment of the present invention, each of the sensing sub-electrode regions and each of the sensing sub-electrodes are strip-shaped.

In an embodiment of the present invention, L is three [symbol] five or seven.

In an embodiment of the present invention, each of the plurality of sensing electrode regions is substantially a cross-shaped region.

In an embodiment of the present invention, each of the driving electrodes is formed by a plurality of ring-shaped electrodes arranged along the second axis in parallel, and two adjacent ring-shaped electrodes are electrically connected to each other through a third conductive line, wherein each of the plurality sensing electrode regions is a ring-shaped region, and the sensing electrodes is disposed on the ring-shaped region, wherein each of the plurality of sensing electrodes and the corresponding ring-shaped electrodes are insulated from each other.

In an embodiment of the present invention, at least one second pad is disposed around the ring-shaped electrode of each of the driving electrodes on the substrate, and the second pads and the corresponding ring-shaped electrodes are insulated from each other.

In an embodiment of the present invention, at least one third pad is disposed in each of the plurality of sensing electrodes on the substrate, and the third pads and the sensing electrodes thereof correspondingly are insulated from each other.

The present invention provides a capacitive touch-control apparatus. The capacitive touch-control apparatus comprises a touch-control chip and a capacitive touch-control panel which comprises a substrate, M driving electrodes and a plurality of M×N sensing electrodes.

In an embodiment of the present invention, the touch-control chip comprises a hub circuit and a touch-control circuit. The hub circuit is electrically connected to the driving electrodes through the plurality of first conductive lines, and is electrically connected to the plurality of sensing electrodes through the plurality of second conductive lines, wherein one of the plurality of sensing electrodes of each of the driving electrodes and another one of the plurality of sensing electrodes of each of the driving electrodes are electrically connected to each other in the hub circuit. The touch-control circuit is electrically connected to the hub circuit, and is electrically connected to the plurality of first conductive lines through the hub circuit so as to transmit a plurality of driving signals to the corresponding driving electrodes sequentially, wherein the touch-control circuit sequentially receives a touch-control signal transmitted from each of the plurality of sensing electrodes.

In summary, the embodiment of the present disclosure provides a capacitive touch-control panel, the capacitive touch-control panel makes area associated with the driving electrodes being larger than total area of the sensing electrodes through design so as to acquire larger signal to noise ratio, elevate accuracy of positioning location for touch point and elevate a yield for capacitive touch-control panel.

For further understanding of the present invention, reference is made to the following detailed description illustrating the embodiments and examples of the present invention. The description is only for illustrating the present invention, not for limiting the scope of the claim.

### BRIEF DESCRIPTION OF THE DRAWINGS

FIG. 1A shows a schematic diagram of the capacitive touch-control panel according to one embodiment of the present disclosure;

FIG. 1B shows a detailed schematic diagram of the sensing electrodes in the capacitive touch-control panel apparatus according to one embodiment of the present disclosure;

FIG. 2A shows a schematic diagram of the capacitive touch-control panel according to another one embodiment of the present disclosure;

FIG. 2B shows a detailed schematic diagram of the sensing electrode for the capacitive touch-control panel according to another one embodiment of the present disclosure;

FIG. 3A shows a schematic diagram of the capacitive touch-control panel according to another one embodiment of the present disclosure;

FIGS. 3B˜3D show detailed schematic diagram of sensing electrode for the capacitive touch-control panel according to another one embodiment of the present disclosure;

FIG. 4A shows a schematic diagram of the capacitive touch-control panel according to another one embodiment of the present disclosure.

FIG. 4B shows a detailed schematic diagram of the sensing electrode for the capacitive touch-control panel according to another one embodiment of the present disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the present disclosure. As used herein, the term “and/or” includes any and all combinations of one or more of the associated listed items.

[Embodiment of a Capacitive Touch-Control Panel]

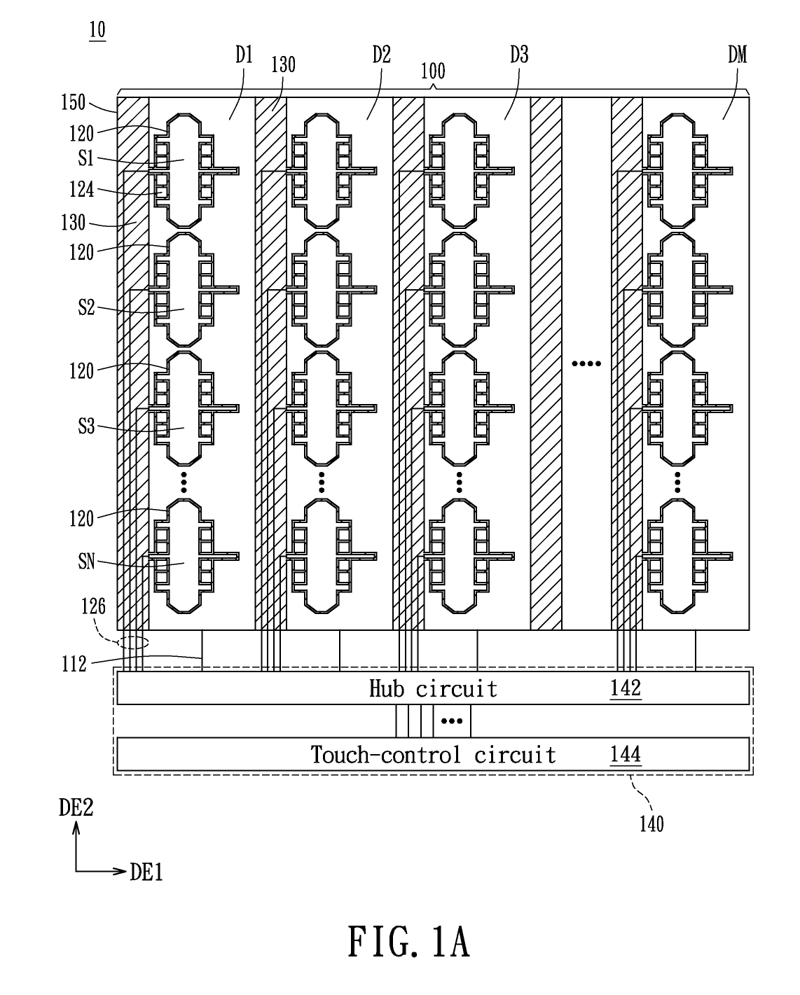

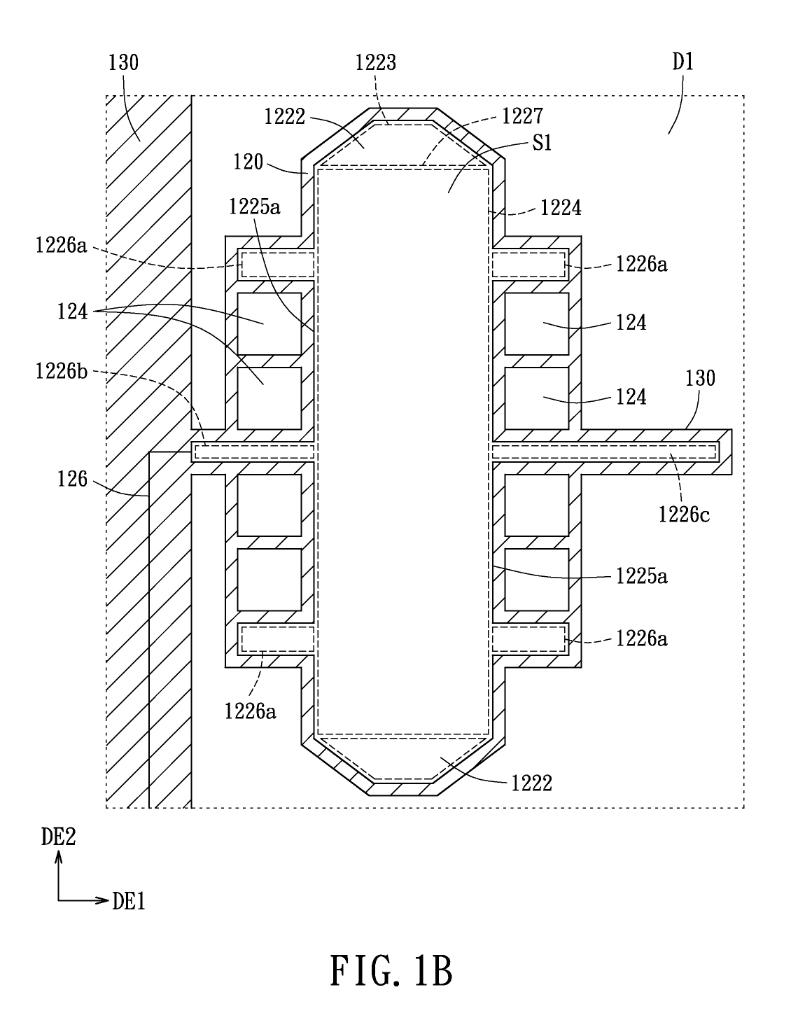

Referring to FIG. 1A, FIG. 1A shows a schematic diagram of the capacitive touch-control panel according to one embodiment of the present disclosure. The capacitive touch-control panel apparatus 10 includes a capacitive touch-control panel 100 and touch-control chip 140. The capacitive touch-control panel 100 is single-layer capacitive and includes a substrate 150, M driving electrodes D1˜DM and a plurality of M×N sensing electrodes S1˜SN, wherein M [symbol] N are positive integer.

The driving electrodes D1˜DM are arranged on the substrate 150 along a first axis DE1, e.g. X axis, and are parallel to a second axis DE2, e.g. Y axis. The substrate 150 is an insulating and transparent substrate and has a plurality of first insulating regions 130 which are transparent. The plurality of first insulating regions 130 are disposed on two sides of each of the driving electrodes D1˜DM so that the driving electrodes D1˜DM are insulated from each other.

It is to be noted that, in the embodiment, an insulating layer is formed on the substrate 150 so that the driving electrodes D1˜DM and the plurality of M×N sensing electrodes S1˜SN are formed on the substrate 150 at the same time. The plurality of first insulating regions 130 are composed of portion of the insulating layer outside the region of the driving electrodes D1˜DM and the plurality of M×N sensing electrodes S1˜SN.

Each of the driving electrodes D1˜DM has N sensing electrode regions 120 along the second axis DE2. The plurality of sensing electrodes S1˜SN are disposed on the substrate 150 in the sensing electrode regions 120. The driving electrodes D1˜DM and the plurality of sensing electrodes S1˜SN are insulated from each other electrically.

In this embodiment, area associated with each of the driving electrodes D1˜DM is larger than area associated with each of plurality of sensing electrodes S1˜SN, and area associated with driving electrode D1 is larger than total area associated with the sensing electrodes S1˜SN. Each of the plurality of sensing electrodes S1˜SN has a plurality of transparent regions, and the plurality of transparent regions set a first pad 124 respectively so as to reduce visibility of the corresponding sensing electrodes S1˜SN. The electric potential of the first pad 124 is float so as to reduce noise level.

The driving electrodes D1˜DM are electrically connected to the touch-control chip 140 through the plurality of first conductive lines 112 so as to sequentially receive a plurality of driving signals transmitted from the touch-control chip 140. Each of the plurality of first conductive lines 112, as shown in FIG. 1A, is electrically connected to any one end of the corresponding driving electrodes D1˜DM. The plurality of sensing electrodes S1˜SN are electrically connected to the touch-control chip 140 through the plurality of second conductive lines 126 so as to transmit the sensing signal to the touch-control chip 140. The plurality of first conductive lines 112 and the plurality of second conductive lines 126 are not intersecting so as to be insulated from each other. In this embodiment, although the plurality of first conductive lines 112 are disposed on the first insulating region 130 and electrically connected to the touch-control chip 140, the present disclosure is not limited thereto. Additionally, each of the driving electrodes D1˜DM and any one of the plurality of sensing electrodes S1˜SN disposed on the sensing electrode regions 120 may generate mutual capacitance.

The touch-control chip 140 transmits the driving signal to the corresponding driving electrodes D1˜DM through the first conductive line 112 according to the predetermined scanning time, so as to scan the capacitive touch-control panel for sensing a location of the touch point. More specifically, the touch-control chip 140 receives the sensing signals transmitted from each of the sensing electrodes S1˜SN corresponding to the driving electrodes D1˜DM through the plurality of second conductive lines 126 as scanning, so that the touch-control chip 140 senses the variation of mutual capacitance between each of the sensing electrodes S1˜SN and the corresponding driving electrodes D1˜DM thereof. When any one of the plurality of sensing electrodes S1˜SN is touched, the sensing signal outputted from the corresponding second conductive line may generate voltage variation, and thus the touch-control chip 140 may acquire least one coordinate of the touch point according to the driving signal and the voltage variation of the touch-control signal. Accordingly, the capacitive touch-control panel may not only sense for single-touch position, but also detect for multi-touch positions.

In the embodiment, the touch-control chip 140 includes a hub circuit 142 and a touch-control circuit 144. The hub circuit 142 is electrically connected to the touch-control circuit 144. One of sensing electrodes S1˜SN on the N sensing electrode regions 120 of the driving electrode D1˜DM is electrically connected to another one of sensing electrodes S1˜SN on the N sensing electrode regions 120 of the driving electrode D1˜DM in the hub circuit 142.

In other words, each of the sensing electrodes S1˜SN of the driving electrode D1 is electrically connected to one of the sensing electrodes S1˜SN of the other driving electrodes D2˜DM. In short, the sensing electrodes S1˜SN of the different driving electrodes D1˜DM are electrically integrated in the hub circuit 140 by one-to-one manner. Accordingly, the hub circuit 142 may collect the sensing signals of the sensing electrodes S1˜SN of the different driving electrodes D1˜DM and transmit the sensing signals to the touch-control circuit 144 so as to proceed judgment of the touch-control position. Therefore, the capacitive touch-control panel 10 in the present disclosure may, efficiently reduce the number of pin used for making the second conductive lines be connected to the touch-control circuit 144, reduce complexity of the circuit layout design and the layout space in demand, and thus the present disclosure may reduce a cost of design and manufacture.

For example, the sensing electrode S1 of the driving electrodes D1˜DM is connected in short in the hub circuit 142, the sensing electrode S2 of the driving electrodes D1˜DM is connected in short in the hub circuit 142, and similarly, the sensing electrode SN of the driving electrodes D1˜DM is connected in short in the hub circuit 142. Accordingly, the hub circuit 142 may collect the sensing signals of the sensing electrode S1 of the driving electrodes D1˜DM, and similarly, the hub circuit 142 may collect the sensing signals of the sensing electrode S1 of the driving electrodes D1˜DM.

In another embodiment, the touch-control chip 140 only includes the touch-control circuit 144. In other words, each of the plurality of sensing electrodes S1˜SN is directly connected to the touch-control circuit 144 through the plurality of the second conductive lines 126. The touch-control circuit 144 receives the sensing signals transmitted from the plurality of second conductive lines 126 corresponding to the plurality of sensing electrodes S1˜SN so as to judge the position of touch point.

The driving electrodes D1˜DM, the plurality of sensing electrodes S1˜SM, the first pad 124, the first conductive lines 112 and the second conductive lines 126 may be manufactured on the substrate 150 through exposure, develop and etching of the lithography process. The substrate 150 may be composed of a glass, a plastic or other transparent material with insulating characteristic. The driving electrodes D1˜DM, the sensing electrodes S1˜SM and the first pad 124 may be manufactured with transparent and conductive material, such as indium tin oxide, Indium zinc oxide, antimony tin oxide or aluminum oxide. The first conductive lines 112 and the second conductive lines 126 may be manufactured with transparent and conductive material or metallic material (e.g. gold, silver or copper). The first insulating region 130 may be manufactured with a transparent and insulating material, such as silica, polyethylene or glass.

The touch-control chip 140 may, in this embodiment, be disposed on the substrate 150. For example, the touch-control chip 140 may be disposed on or embedded into the substrate 150 with technology of the chip on glass. Alternatively, the touch-control chip 140 may be disposed on the substrate 150 by means of the adhesion through an adhesive material. Moreover, the touch-control chip 140 may be also disposed on the flexible printed circuit board, and the touch-control chip 140 is connected to the M×N sensing electrodes S1˜SN and the driving electrodes D1˜DM of the capacitive touch-control panel 100 through the flexible printed circuit board. It is to be noted that the manner of disposing and the arranging for the touch-control chip 140 may be disposed according to a demand of real process or circuit layout, but the present disclosure is not limited thereto.

Referring to FIG. 1B, FIG. 1B shows a detailed schematic diagram of the sensing electrodes in the capacitive touch-control panel apparatus according to one embodiment of the present disclosure. Herein, taking the sensing electrode S1 of the driving electrode D1 as an example for explanation, the person skilled in the art may understand the structure of the other sensing electrodes S2˜SN in this manner.

As shown in FIG. 1B, the sensing electrode S1 and the corresponding driving electrode D1 are insulated from each other. The sensing electrode S1 is disposed on the sensing electrode region 120. The sensing electrode S1 includes at least two first portions 1222 relative to each other, a second portion 1224 and a plurality of protrusion portion 1226a˜1226c. The second portion 1224 is connected between the two first portions 122 relative to each other. The second portion 1224 is roughly rectangle-shaped and the protrusion portion 1226a˜1226c is connected to two long sides 1225a relative to each other of the second portion 1224.

Each of the first portions 1222 has a first side 1223 and a second side 1227 relative to the first side 1223, wherein the second side 1227 is connected to one short side of the second portion 1224 (the short side is adjacent to two long sides 1225a). The first portion 1222 is roughly trapezium-shaped, so the second side 1227 is larger than the first side 1223. In other words, the width of the first portion 1222 increase gradually along a direction from the first side 1223 to the second side 1227.

As shown in FIG. 1B, the length of the protrusion portion 1226b and 1226c are not equal, and the length of the protrusion portions 1226a is equal to each other. The protrusion portions 1226b and 1226c are located between two adjacent protrusion portions 1226a, and the length of protrusion portions 1226b and 1226c is larger than the length of the protrusion portion 1226a. It is to be noted that the length, structure and arrangement of the protrusion portions 1226a, 1226b and 1226c are not restricted thereto.

Additionally, the second conductive line 126 is electrically connected to the protrusion portion 1226b, so as to transmit the sensing signal of the sensing electrode S1 to the touch-control chip 140 at the corresponding predetermined scanning time.

In the sensing electrode S1, at least one first pad 124 is disposed on the transparent region between two adjacent protrusion portions 1226a-1226b and 1226b-1226c, so as to balance the visual difference and reduce visibility of the sensing electrode S1. For example, at least two first pads 124 are disposed between the protrusion portions 1226a and 1226b, and similarly, at least two first pads 124 are disposed between the protrusion portions 1226a and 1226c. The first pads 124 are insulated from each other. Moreover, the size and shape of the first pad 124 may be set according to the size and shape of the transparent region between the adjacent protrusion portions 1226a, 1226b and 1226c. In short, the size and shape of the first pad 124 is not for restricting the scope of the present disclosure.

In this embodiment, the first pad 124 is float, but the first pad 124 may be also connected to ground through the arrangement of the conductive lines so as to define the voltage level of the first pad 124. Additionally, amount of the first pad 124 may be disposed according to visual demand of the capacitive touch-control panel 100, value of the mutual capacitance generated between the driving electrodes D1˜DM and the sensing electrodes S1˜SN, and signal to noise ratio of the touch-control signal. In short, the amount and the voltage of the first pad 124 are not used for limiting the present disclosure.

Incidentally, the present disclosure may also add a reference signal line (not shown) around the sensing electrode S1, and then the reference signal line serves as comparison signal for the sensing signal so as to avoid the sensing electrode S1 being affected by the wireless interference signal, leading to malfunction of the touch-control circuit 144. The reference signal line and the corresponding sensing electrode S1 are insulated from each other. Additionally, because the circuit area of the reference signal line is smaller than area of the sensing electrode S1, the value of the mutual capacitance generated between the sensing electrode S1 and the driving electrode D1 is much larger than the variation for the value of the mutual capacitance sensed by the reference signal line as the location of the sensing electrode S1 is touched without any wireless interference signal, so as to determine whether the sensing electrode is touched.

[Another One Embodiment of the Capacitive Touch-Control Panel]

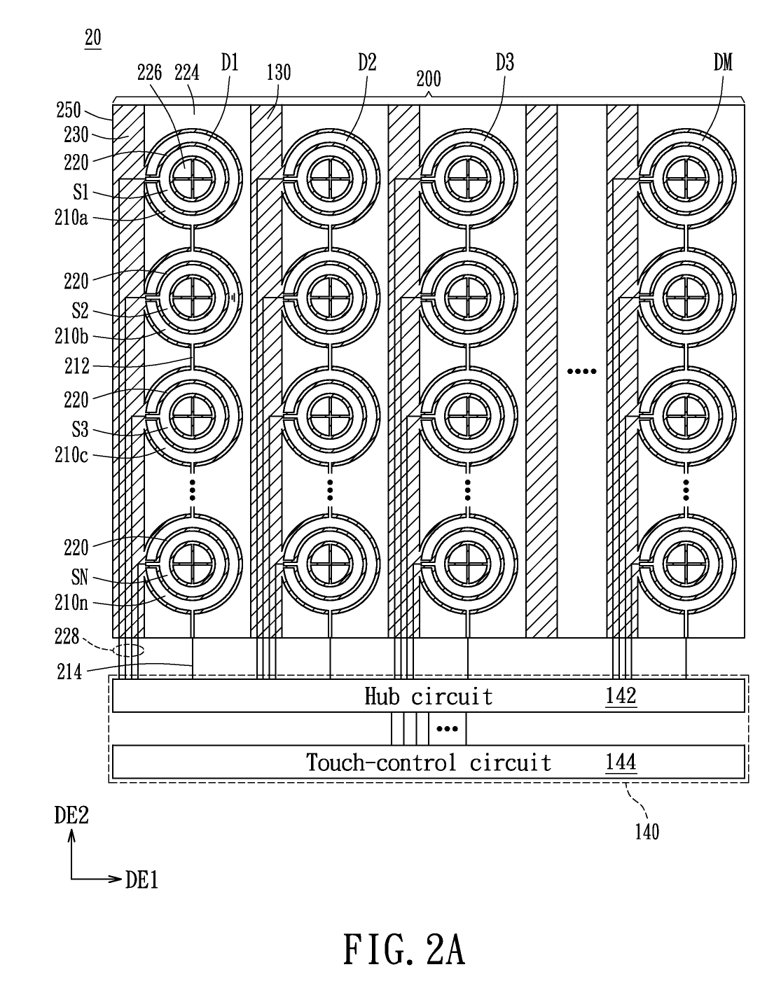

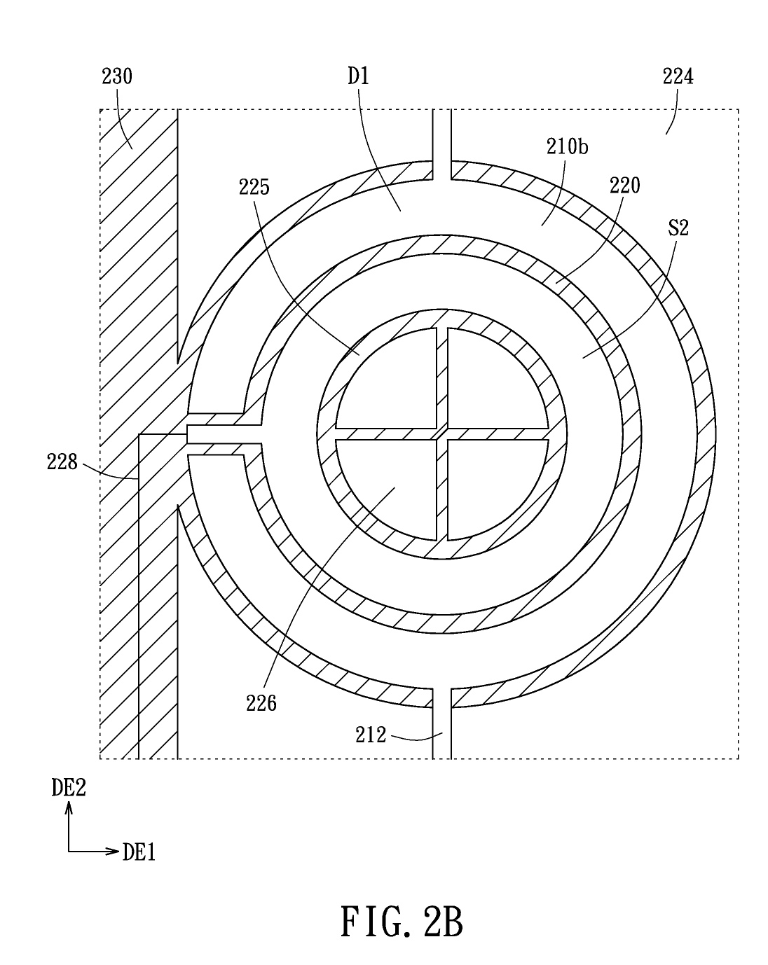

Referring to FIG. 2A, FIG. 2A shows a schematic diagram of the capacitive touch-control panel according to another one embodiment of the present disclosure. In this embodiment, the capacitive touch-control panel apparatus 20 includes capacitive touch-control panel 200 and the touch-control chip 40. The capacitive touch-control panel 200 may also be single-layer capacitive touch-control panel. The capacitive touch-control panel 200 includes the substrate 250, M driving electrodes D1˜DM and a plurality of M×N sensing electrodes S1˜SN, wherein M and N are positive integer.

The M driving electrodes D1˜DM are disposed on the substrate 250, wherein the M driving electrodes D1˜DM are arranged along a first axis DE1, and parallel to a second axis DE2. The substrate 250 is an insulating and transparent substrate, the substrate 250 has a plurality of second insulating areas 230 so that the M driving electrodes D1˜DM are insulated from each other. It is to be noted that, in this embodiment, an insulating layer is formed on the substrate 250 so that the M driving electrodes D1˜DM and the plurality of M×N sensing electrodes S1˜SN are disposed on the substrate 250 at the same time. Moreover, the plurality of second insulating regions 230 are composed of portion of the insulating layer outside the region of the driving electrodes D1˜DM and the plurality of M×N sensing electrodes S1˜SN.

Each of the driving electrodes D1˜DM has N sensing electrode regions 220 along the second axis DE2. The plurality of sensing electrodes S1˜SN are disposed on the substrate 250 in the sensing electrode regions 220. The driving electrodes D1˜DM and the plurality of sensing electrodes S1˜SN are insulated from each other electrically. Each of the driving electrodes D1˜DM is electrically connected to the touch-control chip 140 through the first conductive line 214 so as to receive the corresponding driving signal. Each of the plurality of sensing electrodes S1˜SN is electrically connected to the touch-control chip 140 through the second conductive line 228 so as to transmit the sensing signal to the touch-control chip 140.

Compared with the embodiment in aforementioned FIG. 1A, in this embodiment, each of the driving electrodes D1˜DM is formed by N ring-shaped electrodes arranged along the second axis DE2. The sensing electrode region is ring-shaped region, and the shape of the sensing electrodes S1˜SN disposed in the corresponding sensing electrode regions 220 may also be ring-shaped. In other words, each of the ring-shape electrodes 210a˜210n surround the corresponding sensing electrodes S1˜SN. The area associated with each of the ring-shaped electrodes 210a˜210n is larger than the area of the corresponding sensing electrodes S1˜SN. In other words, the area occupied by each of the driving electrodes D1˜DM is larger than the area occupied by each of the sensing electrodes S1˜SN. Furthermore, the area occupied by each of the driving electrodes D1˜DM is larger than the total area occupied by the corresponding sensing electrodes S1˜SN.

It is worth mentioning that, compared with the aforementioned sensing electrodes S1˜SN in FIG. 1A and FIG. 1B, because the shape of the sensing electrodes S1˜SN is relatively simple, it is easy to control the amount of variation of sensing for the sensing electrodes S1˜SN, i.e. the value of the mutual capacitance between the driving electrodes and the sensing electrodes, through changing a size of the driving electrodes D1˜DM and the sensing electrodes S1˜SN.

Each of the sensing electrodes S1˜SN and the corresponding ring-shaped electrode 210a˜210n may generate the effect of the mutual capacitance. For example, the sensing electrode S1 of the driving electrode D1 and the ring-shaped electrode 210a of the driving electrode D1 may generate the effect of the mutual capacitance. Similarly, the sensing electrode SN of the driving electrode D1 and the ring-shaped electrode 210n may generate the effect of the mutual capacitance. Additionally, the amount of the ring-shaped electrodes 210a˜210n is equal to the amount of the sensing electrode regions 220 correspondingly.

Moreover, the ring-shaped electrode 210a˜210n of each of the driving electrodes D1˜DM are connected to each other through the third conductive line 212. In other words, the ring-shaped electrode 210a is electrically connected to the ring-shaped electrode 210b, the ring-shaped electrode 210b is electrically connected to the ring-shaped electrode 210c, and similarly, the ring-shaped electrode 210n−1 is electrically connected to the ring-shaped electrode 210n.

The ring-shaped connected to each other in series is electrically connected to the touch-control chip 140, through a first conductive line 214, so as to receive the driving signal transmitted from the touch-control chip 140 at the predetermined scanning time. Furthermore, the last ring-shaped electrode 210n of each of the driving electrodes D1˜DM is electrically connected to the touch-control chip 140 through the first conductive line 214. It is worth mentioning that any one of the ring-shaped electrodes 210a˜210n for each of the driving electrodes D1˜DM may be electrically connected to the touch-control chip 140. In other words, as long as the ring-shaped electrodes 210a˜210n of each of the driving electrodes D1˜DM concurrently receive the driving signals transmitted from the touch-control chip 140, but the present is not restricted thereto.

The ring-shaped electrodes 210a˜210n of each of the driving electrodes D1˜DM has an opening, and the second conductive line 228 is electrically connected to the corresponding sensing electrodes S1˜SN through the opening. Accordingly, the touch-control chip 140 receive the sensing signal corresponding to the sensing electrodes S1˜SN through the second conductive line 228 at the predetermined scanning time.

Additionally, a plurality of second pads 224, which are floated, are disposed around the ring-shaped electrodes 210a˜210n of the driving electrodes D1˜DM, are used for filling the transparent region outside the driving electrodes D1˜DM so as to reduce the visibility for the ring-shaped electrodes 210a˜210n of the driving electrode 210. In the embodiment, the area associated with the second pad 224 is larger than the area of each of the ring-shaped electrodes 210a˜210n. The second pads 224 and the ring-shaped electrodes 210a˜210n are electrically insulated from each other. For example, the transparent region between the ring-shaped electrodes 210a, 210b on the substrate 250 may be filled with the second pads 224, which are floated.

Additionally, the substrate 250 may be composed of a glass, a plastic or other transparent material with insulating characteristic. The driving electrodes D1˜DM, the sensing electrodes S1˜SM, the second pad 224 and the third pad 226 may be manufactured with transparent and conductive material, such as indium tin oxide, Indium zinc oxide, antimony tin oxide or aluminum oxide. The first conductive lines 214 and the second conductive lines 228 may be manufactured with transparent and conductive material or metallic material (e.g. gold, silver or copper). The second insulating region 230 may be manufactured with a transparent and insulating material, such as silica, polyethylene or glass.

It is to be noted that the operation for the capacitive touch-control panel 200 is substantially equal to the operation for the capacitive touch-control panel 100. A person skilled in the art is capable of analogizing the operation for the capacitive touch-control panel 200 from the aforementioned embodiment, so there is no need to go into detail. Moreover, FIG. 2A is only for explaining a schematic diagram for the capacitive touch-control panel 200 and a structural schematic diagram for the sensing electrodes S1˜SN, which are not used for restricting the present disclosure.

Referring to FIG. 2B, FIG. 2B shows a detailed schematic diagram of the sensing electrode for the capacitive touch-control panel according to another one embodiment of the present disclosure. Hereinafter, taking the sensing electrode S2 of the driving electrode D1 as an example for explanation, the structure for the other sensing electrodes S1˜SN are similar to the structure for the sensing electrode S2.

The ring-shaped electrode 210b of the driving electrode D1 set a sensing electrode region 220 with ring-shaped. As shown in FIG. 2B, the sensing electrode S2 with ring-shaped is disposed within the sensing electrode region 220. The second pad 224, which is floated, is disposed around the ring-shaped electrode 210b.

The central region of the sensing electrode S2 has a transparent region 225 with circle-shaped, and at least one third pad 226 is disposed in the transparent region 225 with circle-shaped so as to reduce the visibility of the sensing electrode S2. For example, there are four third pads 226 with quarter circle, which are the same size substantially, are disposed in the transparent region 225. The third pads 226 are insulated from each other, and the third pads 226 are electrically insulated from the sensing electrode S2.

The value of the mutual capacitance for the sensing electrode S2 and the corresponding ring-shaped electrode 210b may be adjusted through the arrangement of the third pads 226, so as to reduce the noise level of the sensing electrode S2 and signal to noise ratio. Accordingly, the amount [symbol] size and position of the third pad 226 may be arranged according to a demand of the visibility for the sensing electrode S2, and the value of the mutual capacitance of the ideal sensing electrode S2 and the corresponding ring-shaped electrode 210b, the present disclosure is not restricted thereto.

Moreover, the ring-shaped electrode 210b is electrically connected to the ring-shaped electrode 210a and the ring-shaped electrode 210c through the third conductive line 212 respectively. The ring-shaped electrode 210b has an opening so that the second conductive line 228, disposed in the second insulating region 230, is electrically connected to the sensing electrode S2. The second conductive line 228 and the ring-shaped electrode 210b are electrically insulated from each other. It is worth mentioning that, in another one embodiment, the sensing electrode S2 also has an opening so that the third pad 226 corresponding to the sensing electrode S2 is connected to the ground through the conductive line for controlling the electrical potential of the third pad 226, but the present disclosure is not restricted thereto.

Additionally, the shape and size of the sensing electrode S2 is not need to be equal to the shape and size of sensing electrode region 220. The sensing electrode S2 is also formed by a plurality of sensing sub-electrode (not shown in FIG. 2B) connected to each other with the same shape or different shape. In other words, the sensing electrode S2 is formed by the plurality of sensing sub-electrode connected to each other in the sensing electrode region 220. The shape of the sensing electrode may be formed by the sensing sub-electrode with any kind of geometry, such as circle, square, rectangle, rhombus, ellipse or pentagon. In other words, the shape [symbol] size and arrangement of the sensing electrode S2 may be emplaced according to a demand of the process or sensing design for touch-control in the sensing electrode region 220. As long as the total area of the sensing electrode S2 in the sensing electrode region 220 is smaller than the area of the corresponding driving electrode D1, the present disclosure is not restricted thereto.

[Another Embodiment of a Single-Layer Capacitive Touch-Control Panel]

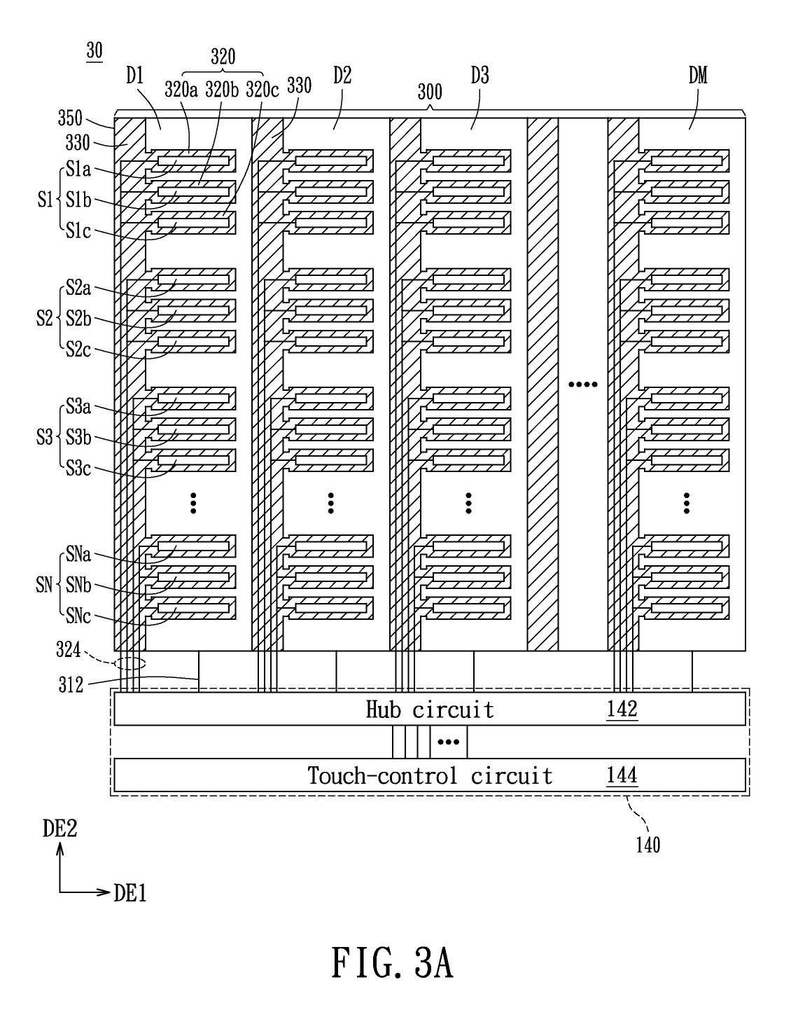

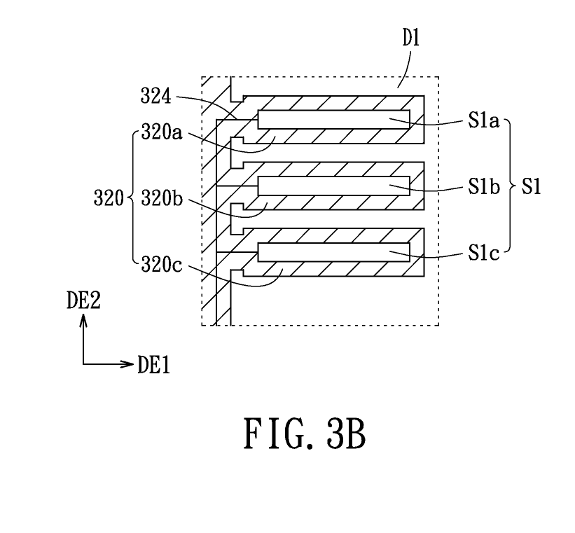

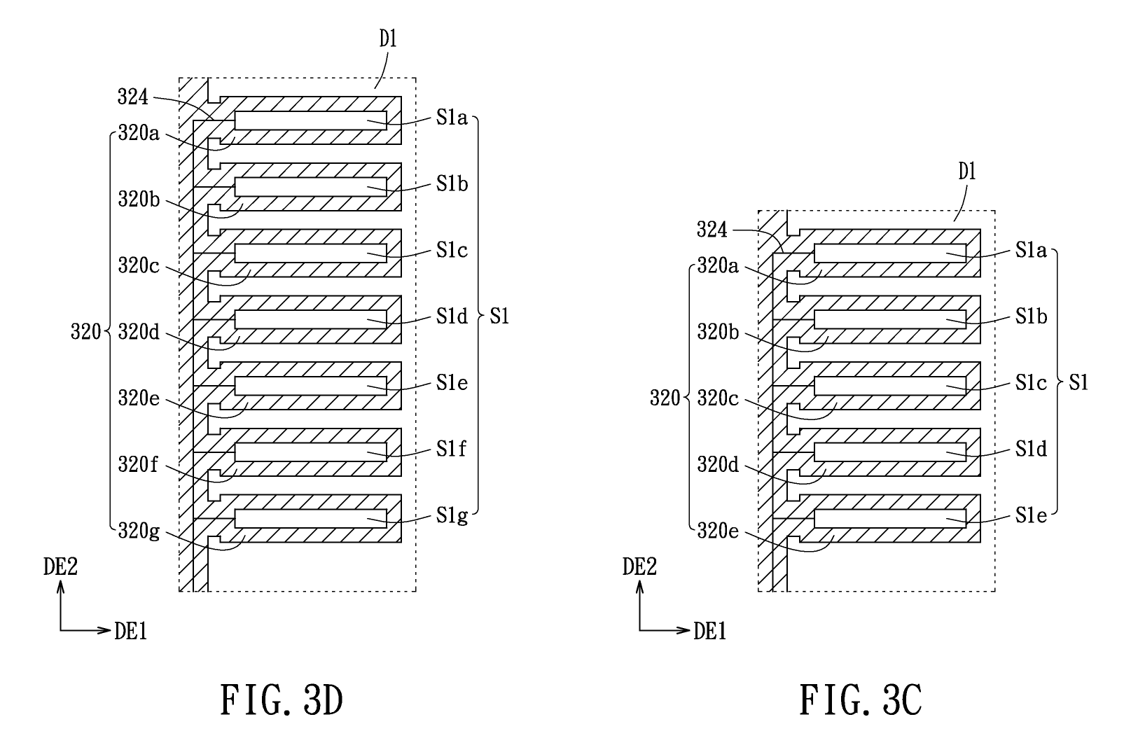

Next, referring to FIG. 3A, FIG. 3A shows a schematic diagram of the capacitive touch-control panel according to another one embodiment of the present disclosure. In this embodiment, the capacitive touch-control panel apparatus 30 includes a capacitive touch-control panel 300 and a touch-control chip 40. The capacitive touch-control panel 300 may also be a single-layer capacitive touch-control panel, and the capacitive touch-control panel 300 includes a substrate 350, M driving electrodes D1˜DM and a plurality of M×N sensing electrodes S1˜SN, wherein M and N are positive integer.

The M driving electrodes D1˜DM are disposed on the substrate 350, wherein the M riving electrodes D1˜DM are arranged along a first axis DE1, and parallel to a second axis DE2. The substrate 250 is insulating and transparent substrate, and the substrate 250 has a plurality of third insulating region 330 so that the M driving electrodes D1˜DM are insulated from each other. It is to be noted that, in the embodiment, an insulating layer is formed on the substrate 350 so as to the driving electrodes D1˜DM and the plurality of M×N sensing electrodes S1˜SN are formed on the substrate 350 at the same time. The plurality of third insulating regions 330 are composed of portion of the insulating layer outside the region of the driving electrodes D1˜DM and the plurality of M×N sensing electrodes S1˜SN.

Each of the driving electrodes D1˜DM has N sensing electrode regions 320, and the plurality of sensing electrode S1˜SN are disposed on the substrate 350 in the sensing electrode regions 320. The driving electrodes D1˜DM and the plurality of sensing electrodes S1˜SN are insulated from each other electrically. Each of the driving electrodes D1˜DM is electrically connected to the touch-control chip 140 through a plurality of first conductive lines 312 so as to receive the corresponding driving signal. Each of the sensing electrodes S1˜SN is electrically connected to the touch-control chip 140 through a plurality of second conductive lines 324 so as to transmit the sensing signal to the touch-control chip 140.

Compared with the embodiment in FIG. 1A, the N sensing electrode regions 320 defined in the each of the driving electrodes D1˜DM are formed by a plurality of sensing sub-electrode regions 320a˜320c arranged along the second axis DE2. At least one sensing sub-electrode, e.g. S1a˜S1c [symbol] S2a˜S2c [symbol] . . . [symbol] SNa˜SNc, is disposed in the sensing sub-electrode region 320a˜320c respectively. Each of the sensing electrodes S1˜SN is formed by the sensing sub-electrodes disposed in the sensing electrode region 320 through the second conductive lines 324.

In the embodiment, each of the sensing electrode regions 320 is comb-shaped, and the sensing electrode S1˜SN disposed in each of the sensing electrode region 320 is comb-shaped. The sensing electrode S1˜SN and the driving electrode D1˜DM are arranged by means of cross finger. More specifically, the sensing sub-electrode regions 320a˜320c are strip-shaped respectively, and the sensing sub-electrodes, e.g. S1a˜S1c [symbol] S2a˜S2c [symbol] . . . [symbol] SNa˜SNc, are disposed in the sensing sub-electrode region 320a˜320c and may also be strip-shaped.

The area associated with each of the driving electrodes D1˜DM is larger than the area of the corresponding sensing electrodes S1˜SN. Moreover, the area associated with each of the driving electrodes D1˜DM is larger than the total area of the sensing electrodes S1˜SN. Compared with the sensing electrodes S1˜SN in FIG. 1A and FIG. 1B, the circuit with the sensing electrodes S1˜SN has a flexibility for design, and adapted to sense variation of the touch-control for smaller area. For example, the variation is generated from the touch of the touch-control pen. The amount and size of the sensing electrode region 320a˜320c included in the sensing electrode region 320 may be adjusted according to the demand of the actual product, but the present embodiment is not restricted thereto.

Each of the sensing sub-electrodes 320a˜320c disposed on the each of sensing electrodes S1˜SN and the corresponding driving electrodes D1˜DM may generate mutual capacitance. For example, the sensing sub-electrodes S1a˜S1c of the sensing electrode S1 and the corresponding driving electrode D1 may generate mutual capacitance. The sensing sub-electrodes S2a˜S2c of the sensing electrode S2 and the corresponding driving electrode D1 may generate mutual capacitance, and similarly, the sensing sub-electrodes SNa˜SNc of the sensing electrode SN and the corresponding driving electrode D1 may generate mutual capacitance.

Additionally, each of the driving electrodes D1˜DM is electrically connected to the touch-control chip 140 through a first conductive line 312 so as to receive the driving signal transmitted from the touch-control chip 140 at the predetermined scanning time. Each of the sensing electrode S1˜SN is electrically connected to the touch-control chip 140 through a second conductive line 324 so as to transmit the sensing signal to the touch-control chip 140. The second conductive lines 324, insulated from each other, are disposed on the third insulating region 330 respectively, and are not intersecting. The first conductive lines 312 and the second conductive lines 326 are not intersecting and insulated from each other.

It is to be noted that the operation for the capacitive touch-control panel 300 is substantially equal to the operation for the capacitive touch-control panel 100. A person skilled in the art is capable of analogizing the operation for the capacitive touch-control panel 300 from the aforementioned embodiment, so there is no need to go into detail. Moreover, FIG. 3A is only for explaining a schematic diagram for the capacitive touch-control panel 300 and a structural schematic diagram for the sensing electrodes S1˜SN, which are not used for restricting the present disclosure.

Referring to FIGS. 3B˜3D, FIGS. 3B˜3D show detailed schematic diagrams of the sensing electrodes of the capacitive touch-control panel according to another embodiment of the present disclosure. Hereinafter, taking the sensing electrode S1 of the driving electrode D1 as an example for explanation, the structure for the other sensing electrodes S2˜SN are similar to the structure for the sensing electrode S1.

As shown in FIG. 3B, in this embodiment, the sensing electrode region 320 is formed by at least three sensing sub-electrode regions 320a˜320c with strip-shaped. The sensing sub-electrodes S1a˜S1c are disposed in the sensing sub-electrode regions 320a˜320c respectively, and the sensing sub-electrodes S1a˜S1b form the sensing electrode S1 through the second conductive line 324. In other words, the sensing electrode S1 is arranged with three sensing electrodes S1a˜S1c with strip-shaped, along the second axis DE2 and parallel to the first axis DE1. Each of the sensing electrode regions 320 and the corresponding sensing electrode S1˜SN are E-shaped substantially.

It is worth mentioning that the sensing electrode region 320 formed by the sensing sub-electrode regions 320a˜320e, as shown in FIG. 3C, are formed by the five sensing sub-electrode regions 320a˜320e with strip-shaped. The sensing sub-electrodes S1a˜S1e are disposed in the each of the sensing electrode regions 320a˜320e, and the sensing sub-electrodes S1a˜S1e are strip-shaped respectively. The sensing sub-electrodes S1a˜S1e are electrically connected to each other through the second conductive lines 324. In other words, the sensing electrode S1 may be formed by the five sensing sub-electrodes S1a˜S1e, connected to each other, with strip-shaped. The sensing sub-electrodes S1a˜S1e and the corresponding driving electrode D1 are insulated from each other. Any one of the sensing sub-electrodes S1a˜S1e and the corresponding driving electrode D1 may generate mutual capacitance.

Additionally, the sensing electrode region 320 formed by the sensing sub-electrode regions 320a˜320c, as shown in FIG. 3D, are formed by the seven sensing sub-electrode regions 320a˜320g with strip-shaped. The sensing sub-electrodes S1a˜S1g are disposed in the each of the sensing electrode regions 320a˜320g. In other words, the sensing electrode S1 may be formed by the seven sensing sub-electrodes S1a˜S1g, connected to each other, with strip-shaped. Any one of the sensing sub-electrodes S1a˜S1g and the corresponding driving electrode D1 may generate mutual capacitance.

Additionally, the shape and size of the sensing electrodes S1˜SN disposed on the driving electrodes D1˜DM is not need to be equal to the shape and size of sensing electrode region 220. In other words, the sensing electrodes S1˜SN are formed by the sensing sub-electrodes connected to each other in the sensing electrode region 320. The shape of the sensing sub-electrode, e.g. S1a˜S1c [symbol] S2a˜S2c [symbol] . . . [symbol] SNa˜SNc, may be any kind of the geometry, such as circle, square, rectangle, rhombus, ellipse or pentagon. In short, the shape [symbol] size and arrangement of the sensing electrodes S1˜SN, disposed in the sensing electrode 320, may be emplaced according to a demand of the process or sensing design for touch-control. As long as the total area of the sensing sub-electrodes in the sensing electrode region 320 is smaller than the area of the corresponding driving electrode D1, the present disclosure is not restricted thereto.

For example, taking the sensing electrode S1 of the driving electrode D1, as shown in FIG. 3B, as an example, the sensing electrode S1 may be implemented by that the sensing sub-electrode S1a˜S1c with square [symbol] circle or rhombus are disposed in the sensing sub-electrode region 320a˜320c and connected to each other through the conductive line. Accordingly, according to aforementioned explanation, a person skilled in the art should understand the arrangement and the design of the sensing electrode S1˜Sn, there is no need to go into detail.

Moreover, each of the driving electrodes D1˜DM may be arranged as the structure of the sensing electrode S1˜SN shown in FIG. 3B˜FIG. 3D according to demand of the design. In other words, each of the driving electrodes D1˜DM may be arranged as the structure of the sensing electrodes S1˜SN according to the value of the mutual capacitance. For example, the driving electrode D1 may be arranged as the structure of the sensing electrode S1˜SN as shown in FIG. 3B, the driving electrode D1 may be arranged as the structure of the sensing electrode S1˜SN as shown in FIG. 3C, and similarly, the structure of the sensing electrodes S1˜SN disposed on the driving electrodes D1˜DM may adjust arrangement according to the design demand. It is to be noted that FIGS. 3B˜3D is only for disclosing schematic diagram of the sensing electrodes S1˜SN, but FIGS. 3B˜3D is not restricted the present disclosure.

[Another One Embodiment of a Single-Layer Capacitive Touch-Control Panel]

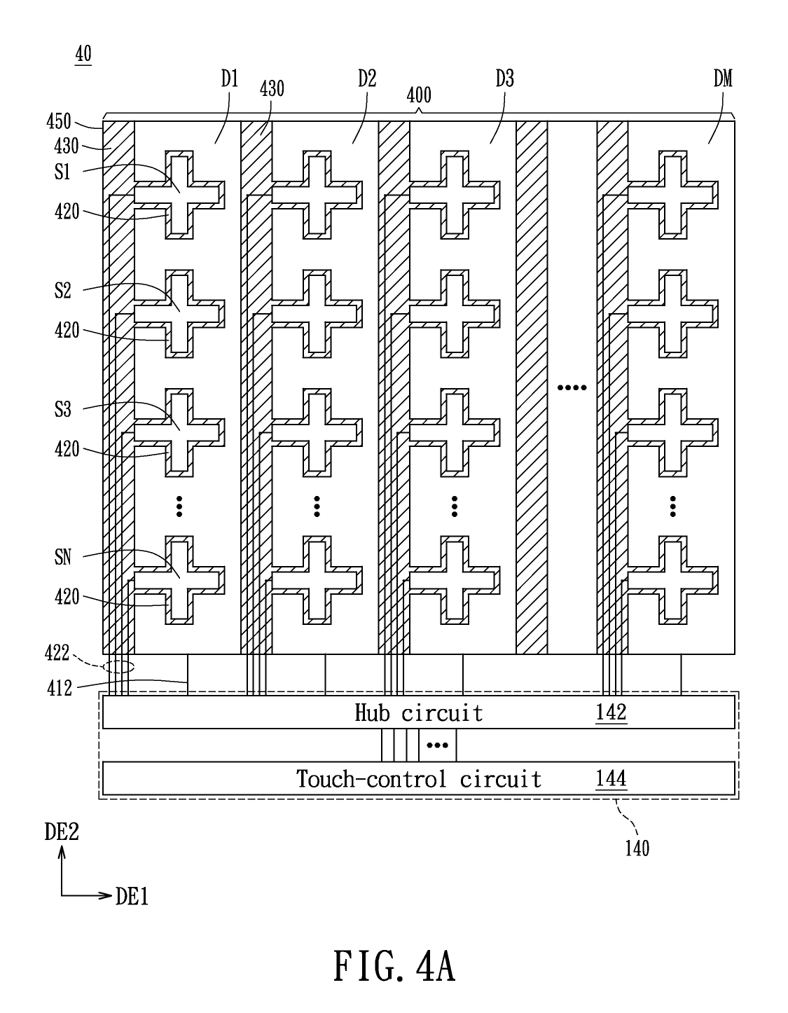

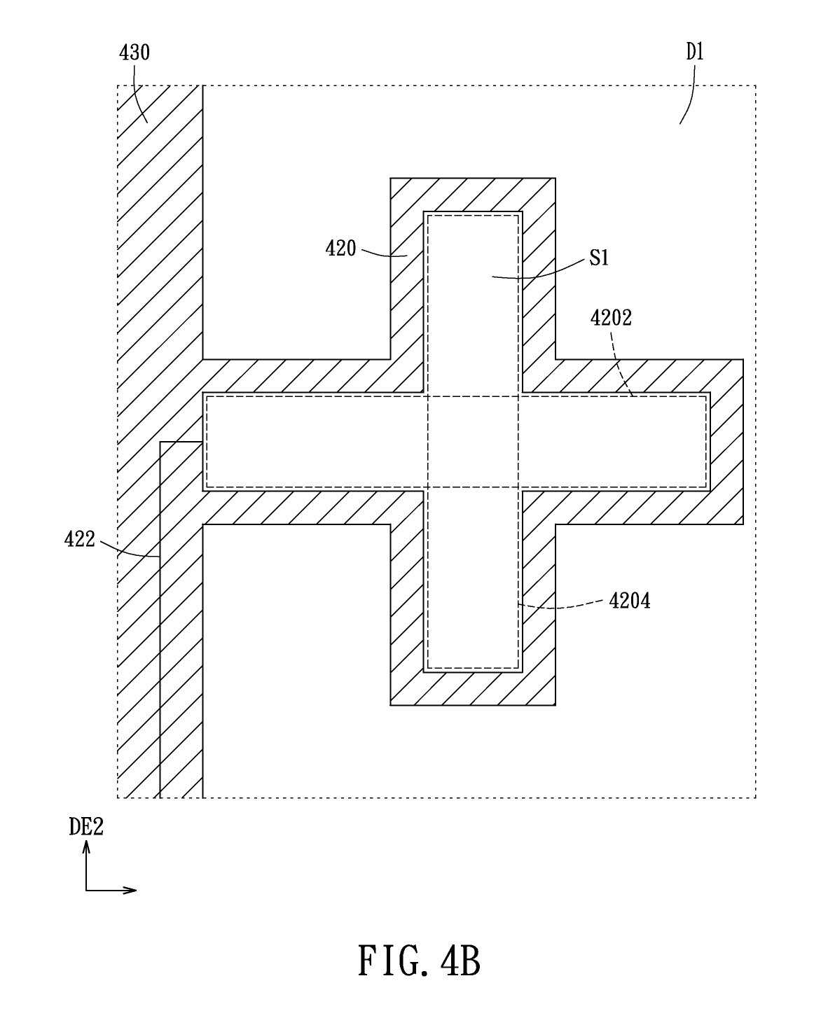

Referring to FIG. 4A, FIG. 4A shows a schematic diagram of the capacitive touch-control panel according to another one embodiment of the present disclosure. In this embodiment, the capacitive touch-control panel apparatus 40 includes a capacitive touch-control panel 400 and a touch-control chip 140. The capacitive touch-control panel 400 may be a single-layer capacitive touch-control panel. The capacitive touch-control panel 400 includes a substrate 450, M driving electrodes D1˜DM and a plurality of M×N sensing electrodes S1˜SN, wherein M and N are positive integer.

The M driving electrodes D1˜DM are disposed on the substrate 450, wherein the M driving electrodes D1˜DM are arranged along a first axis DE1 (e.g. Y axis) and parallel to a second axis DE2 (e.g. Y axis). The substrate 450 is an insulating and transparent substrate and has a plurality of fourth insulating regions 430, so that the M driving electrodes D1˜DM are insulated from each other. It is to be noted that an insulating layer is formed on the substrate 450 so that the driving electrodes D1˜DM and the plurality of M×N sensing electrodes S1˜SN are formed on the substrate 450 at the same time. The plurality of fourth insulating regions 430 are composed of portion of the insulating layer outside the region of the driving electrodes D1˜DM and the plurality of M×N sensing electrodes S1˜SN.

Each of the driving electrodes D1˜DM has N sensing electrode regions 420, and the plurality of sensing electrode S1˜SN are disposed on the substrate 450 in the sensing electrode regions 420. The driving electrodes D1˜DM and the plurality of sensing electrodes S1˜SN are insulated from each other electrically. Each of the driving electrodes D1˜DM and any one of the sensing electrodes S1˜SN disposed in the sensing electrode regions 420 may generate mutual capacitance. Each of the sensing electrodes S1˜SN is electrically connected to the touch-control chip 140 through the second conductive line 422 so as to transmit the sensing signal to the touch-control chip 140. The first conductive line 410 and the second conductive line 422 are not intersecting and insulated from each other.

The difference compared with the embodiment in FIG. 1A is that the shape of each of the sensing electrode regions 420 is substantially cross-shaped, and the sensing electrodes S1˜SN disposed in the sensing electrode regions 420 is also substantially cross-shaped. It is relative simple to design the structure of the sensing electrode S1˜SN, so as to control sensing variation of the sensing electrode S1˜SN through changing size of the sensing electrode S1˜SN, wherein the sensing variation indicate the value of the mutual capacitance generated between the sensing electrode and the driving electrode.

Incidentally, the substrate 450 may be composed of a glass, a plastic or other transparent material with insulating characteristic. The driving electrodes D1˜DM, the sensing electrodes S1˜SM, the first conductive line 412 and the second conductive line 422 may be manufactured with transparent and conductive material, such as indium tin oxide, Indium zinc oxide, antimony tin oxide or aluminum oxide. The third insulating region 430 may be manufactured with a transparent and insulating material, such as silica, polyethylene or glass.

It is to be noted that the operation for the capacitive touch-control panel 400 is substantially equal to the operation for the capacitive touch-control panel 100. A person skilled in the art is capable of analogizing the operation for the capacitive touch-control panel 400 from the aforementioned embodiment, so there is no need to go into detail. Moreover, FIG. 4A is only for explaining a schematic diagram for the capacitive touch-control panel 400 and a structural schematic diagram for the sensing electrodes S1˜SN, which are not used for restricting the present disclosure.

Referring to FIG. 4B, FIG. 4B shows a detailed schematic diagram of the sensing electrode for the capacitive touch-control panel according to another one embodiment of the present disclosure. Hereinafter, taking the sensing electrode S1 of the driving electrode D1 as an example for explanation, the structure for the other sensing electrodes S2˜SN are similar to the structure for the sensing electrode S1.

More specially, as shown in FIG. 4B, the sensing electrode S1 and the corresponding driving electrode D1 are insulated from each other. The sensing electrode S1 is disposed in the sensing electrode region 420. As shown in FIG. 4B, the sensing electrode S1 includes a third portion 4202 and a fourth portion 4204. The third portion 4202 and the fourth portion 4204 are respectively rectangle. The third portion 4202 is substantially parallel to the first axis DE1 and perpendicular to the second axis DE2. The fourth portion 4204 is substantially parallel to the second axis DE2 and perpendicular to the first axis DE1. The third portion 4202 and the fourth portion 4204 are arranged by means of cross finger.

In this embodiment, the width of the third portion 4202, along the second axis DE2, is equal to the width of the fourth portion 4204, along the first axis DE1. In real application, the width for one of the third portion 4202 and the fourth portion 4204 may be larger than another regions, the present disclosure is not restricted thereto. Similarly, in this embodiment, the length of the third portion 4202, along the first axis DE1, is substantially equal to the length of the fourth portion 4204, along the second axis DE2. In real application, the length for one of the third portion 4202 and the fourth portion 4204 may be larger than another regions, the present disclosure is not restricted thereto. Additionally, the second conductive lines 422 is electrically connected to one end of the third portion 4202 so as to transmit the sensing signal to the touch-control chip 140. The second conductive lines 422 are disposed on the fourth insulating region 430.

The shape and size of the sensing electrode S1 is not need to be equal to the shape and size of sensing electrode region 220. The sensing electrode S1 is also formed by a plurality of sensing sub-electrode, in the sensing electrode region 420, connected to each other. The shape of the sensing electrode S1 may be any kind of geometry, such as circle, square, rectangle, rhombus, ellipse or pentagon. In other words, the shape [symbol] size and arrangement of the sensing electrode S1 may be emplaced according to a demand of the process or sensing design for touch-control in the sensing electrode region 420. As long as the total area of the sensing electrode S1 in the sensing electrode region 420 is smaller than the area of the corresponding driving electrode D1, the present disclosure is not restricted thereto. It is to be noted that FIG. 4B is only for explaining a schematic diagram for the capacitive touch-control panel 400 and a structural schematic diagram for the sensing electrodes S1˜SN, which are not used for restricting the present disclosure.

To sum up, the capacitive touch-control panel provided by the present disclosure may cause the area of the driving electrode being larger than the total area of the sensing electrode so as to acquire larger signal to noise ratio, and thus elevate the accuracy of positioning location.

Additionally, the capacitive touch-control panel may adjust the value of the mutual capacitance between the sensing electrode and driving electrode, and reduce the visibility of the sensing electrode and the driving electrode through the arrangement of the pad. Moreover, the present disclosure also provide multiple structure of the sensing electrode, and then one may choose a proper structure of the sensing electrode to be disposed on the touch-control panel according to a demand of the process, the value of the mutual capacitance and the purpose of the touch-control panel. The single-layer capacitive touch-control panel provided by the present disclosure may reduce at least one mask of the lithography process, so as to reduce a cost [symbol] weight and thickness of the manufacturing the touch-control panel.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A capacitive touch-control panel, comprising:
a substrate;
M driving electrodes, insulated from each other; and
a plurality of M×N sensing electrodes,
wherein the M driving electrodes and the plurality of M×N sensing electrodes, located on the same layer, are formed on the substrate, and the driving electrodes arrange along a first axis,
wherein each of the driving electrodes set N sensing electrode regions, and then each of the plurality of sensing electrodes is disposed on the each of the sensing electrode regions so that the N sensing electrodes and the corresponding driving electrodes are insulated form each other, and the N sensing electrodes and the corresponding driving electrodes generate mutual capacitance,
wherein the area associated with each of the driving electrodes is larger than the overall area of the each corresponding sensing electrode, and M [symbol] N are positive integer.

2. The capacitive touch-control panel according to claim 1, wherein each of the driving electrodes receives a driving signal correspondingly through a first conductive line, and each of the sensing electrodes and each of the sensing electrodes transmit a sensing signal corresponding to the sensing electrode through a second conductive line.

3. The capacitive touch-control panel according to claim 2, wherein each of the sensing electrode regions on the substrate has a plurality of transparent regions, and the plurality of transparent regions set at least one first pad, wherein the first pads [symbol] the plurality of sensing electrodes and the driving electrodes are insulated electrically form each other.

4. The capacitive touch-control panel according to claim 3, wherein each of the sensing electrodes has two first portions [symbol] a second portion and a plurality of protrusion portions, and the second portion is located between two adjacent first portions and is connected to the two first portions,
wherein each of the first portions has a first side and a second side relative to the first side, and the second side is connected to the second portion, and the second side is larger than the first side,
wherein the plurality of protrusion portions are connected to the plurality of protrusion portions protrudes from the corresponding second portion,
wherein the pad is disposed between the two protrusion portions and one of the plurality of protrusion portions transmits the sensing signal through the second conductive line.

5. The capacitive touch-control panel according to claim 1, wherein each of the sensing electrode regions has L sensing sub-electrode regions, and the sensing sub-electrode regions arrange along the second axis respectively in parallel,
wherein a plurality of sensing sub-electrodes within the sensing sub-electrode regions are electrically connected to a second conductive line so as to form the sensing electrode, and the second conductive line transmits a sensing signal corresponding to the sensing electrode, wherein L is a positive integer.

6. The capacitive touch-control panel according to claim 5, wherein each of the sensing sub-electrode regions and each of the sensing sub-electrodes are strip-shaped.

7. The capacitive touch-control panel according to claim 5, wherein L is three [symbol] five or seven.

8. The capacitive touch-control panel according to claim 1, wherein each of the plurality of sensing electrode regions is substantially a cross-shaped region.

9. The capacitive touch-control panel according to claim 1, wherein each of the driving electrodes is formed by a plurality of ring-shaped electrodes arranged along the second axis in parallel, and two adjacent ring-shaped electrodes are electrically connected to each other through a third conductive line,
wherein each of the plurality sensing electrode regions is a ring-shaped region, and the sensing electrodes is disposed on the ring-shaped region, wherein each of the plurality of sensing electrodes and the corresponding ring-shaped electrodes are insulated from each other.

10. The capacitive touch-control panel according to claim 9, wherein at least one second pad is disposed around the ring-shaped electrode of each of the driving electrodes on the substrate, and the second pads and the corresponding ring-shaped electrodes are insulated from each other.

11. The capacitive touch-control panel according to claim 9, wherein at least one third pad is disposed in each of the plurality of sensing electrodes on the substrate, and the third pads and the sensing electrodes thereof correspondingly are insulated from each other.

12. The capacitive touch-control panel according to claim 1, further comprising:
a first insulating region, disposed between the two adjacent driving electrodes so that the two adjacent driving electrodes are insulated from each other, and the second line is disposed in the first insulating region.

13. A capacitive touch-control panel apparatus, comprising:
a capacitive touch-control panel, comprising:
a substrate;
M driving electrodes, insulated from each other; and
a plurality of M×N sensing electrodes,
wherein the M driving electrodes and the plurality of M×N sensing electrodes, located on the same layer, are formed on the substrate, and the driving electrodes arrange along a first axis,
wherein each of the driving electrodes set N sensing electrode regions, and then each of the sensing electrodes is disposed on the each of the sensing electrode regions so that the N sensing electrodes and the corresponding driving electrodes are insulated form each other, and the N sensing electrodes and the corresponding driving electrodes generate mutual capacitance,
wherein the area associated with each of the driving electrodes is larger than the overall area of the each corresponding sensing electrode, and M [symbol] N are positive integer; and
a touch-control chip, electrically connected to the driving electrodes and the plurality of sensing electrodes through a plurality of first conductive lines and a plurality of second conductive lines.

14. The capacitive touch-control panel apparatus according to claim 13, wherein the touch-control chip comprises:
a hub circuit, electrically connected to the driving electrodes through the plurality of first conductive lines, electrically connected to the plurality of sensing electrodes through the plurality of second conductive lines, wherein one of the plurality of sensing electrodes of each of the driving electrodes and another one of the plurality of sensing electrodes of each of the driving electrodes are electrically connected to each other in the hub circuit; and
a touch-control circuit, electrically connected to the hub circuit, and electrically connected to the plurality of first conductive lines through the hub circuit so as to transmit a plurality of driving signals to the corresponding driving electrodes sequentially, wherein the touch-control circuit sequentially receives a touch-control signal transmitted from each of the plurality of sensing electrodes.

15. The capacitive touch-control panel apparatus according to claim 14, wherein the touch-control chip is disposed on the substrate with technology of the chip on glass.

16. The capacitive touch-control panel apparatus according to claim 14, wherein a material of the driving electrodes and the plurality of sensing electrodes is transparent conductive film.
